(19) United States
(12) Patent Application Publication
(10) Pub. No.: US 2013/0142071 A1
(43) Pub. Date: Jun. 6, 2013

(54) METHOD AND APPARATUS FOR DECREASING MULTI-CELL FEEDBACK OVERHEAD

(71) Applicant: Hao Liu, PuDong Jinqiao Shanghai (CN)

(72) Inventor: Hao Liu, PuDong Jinqiao Shanghai (CN)

(73) Assignee: ALCATEL LUCENT, Paris (FR)

(21) Appl. No.: 13/816,396

(22) PCT Filed: Jul. 27, 2011
(86) PCT No.: PCT/IB11/02064

§ 371 Date: Feb. 11, 2013

(30) Foreign Application Priority Data
Aug. 9, 2010 (CN) 201010248728.8

(51) Int. Cl. H04W 24/02

(52) U.S. Cl. CPC H04W 24/02
USPC 370/252

(57) ABSTRACT

Method and apparatus for decreasing multi-cell feedback overhead is provided in the present invention. Wherein a user equipment utilizes a first period to feedback short-term channel direction information of a serving base station, utilizes a second period to feedback long-term channel direction information of neighboring base stations, further, the user equipment utilizes a third period to feedback long-term relative amplitude information, utilizes a fourth period to feedback short-term relative phase information, wherein the first period is shorter than the second period, and the third period is longer than the fourth period.

### FIELD OF THE INVENTION

The present invention relates to wireless communication network, more particularly, to method and apparatus for decreasing multi-cell feedback overhead.

### BACKGROUND OF THE INVENTION

Coordinated Multi-Point (CoMP) transmission is an effective manner in LTE-A to reduce inter-cell interference (ICI), increase data rates, strengthen the cell-edge throughput and/or increase system throughput. Multi-cell joint transmission is a CoMP scheme, where data transmission intended for one or more user equipments (UEs) is shared within CoMP cooperating set and is jointly processed among a plurality of cells. Channel information of all the UEs is shared among the coordinated base stations (BSs) through channel quantization feedback and backhaul exchange, for example, usually through the wired connection among BSs, such as fiber-optic connection. Therefore joint multi-cell proportional fair (PF) scheduling and centralized Zero Forcing (ZF) precoding can be performed among the coordinated BSs or in a centralized scheduler. A plurality of UEs can be jointly served by a plurality of BSs in CoMP cooperating set through coordinating transmission so as to improve signal power and reduce inter-cell interference (ICI). Therefore channel information feedback is an important factor in multi-cell joint transmission scheme. Since a larger bundle of channel information depicting a plurality of cells needs to be reported together over uplink feedback control channel, then how to balance the tradeoff between system performance improvement and uplink feedback overhead reduction becomes a very challenging problem for CoMP scheme.

Multi-cell joint transmission scheme highly depends on channel information feedback from each UE. Currently two-stage multi-cell feedback mechanism has been proposed by combining individual per-cell channel feedback with additional inter-cell relative amplitude/phase feedback. With the two-stage feedback mechanism, single-cell MIMO and multi-cell joint transmission scheme can both be supported and flexibly switched between each other.

### SUMMARY OF THE INVENTION

Apparently more channel information from UEs is needed for multi-cell joint transmission, so the trade-off between performance and overhead is a challenging issue in CoMP design.

In order to solve the technology problem above, an effective multi-cell feedback mechanism is proposed in the present invention. The feedback mechanism decreases feedback overhead and will not decrease the CoMP system performance in the meantime.

According to the first aspect of the present invention, a method of feedback in a user equipment in a cell of coordinated multi-point is provided, wherein the user equipment is served by a serving base station and neighboring base stations coordinately, and the method comprises following steps: measuring the channel related information between the user equipment and the serving base station, and between the user equipment and the neighboring base stations respectively; calculating short-term serving channel direction information between the user equipment and the serving base station, long-term neighboring channel direction information between the user equipment and the neighboring base stations, respective relative amplitude information between each one of the neighboring base stations and the serving base station and respective relative phase information between each one of the neighboring base stations and the serving base station according to the channel related information between the user equipment and the serving base station and between the user equipment and the neighboring base stations; calculating multi-cell channel quality information according to the short-term serving channel direction information, the long-term neighboring channel direction information, the relative amplitude information and the relative phase information; feeding back respectively to the serving base station, the short-term serving channel direction information according to a first period and the long-term neighboring channel direction information according to a second period, and feeding back to the serving base station the relative amplitude information, the relative phase information and the multi-cell channel quality information, wherein the first period is shorter than the second period.

According to the second aspect of the present invention, a method of obtaining the feedback of a user equipment in a serving base station is provided, wherein the serving base station and neighboring base stations serve the user equipment coordinately, and the method comprises following steps:—obtaining short-term serving channel direction information between the user equipment and the serving base station according to a first period, obtaining long-term neighboring channel direction information between the user equipment and the neighboring base stations according to a second period, and obtaining respective relative amplitude information between each one of the neighboring base stations and the serving base station and respective relative phase information between each one of the neighboring base stations and the serving base station;—restoring coordinated multi-point quantized channel vector according to the short-term serving channel direction information, the long-term neighboring channel direction information, the relative amplitude information and the relative phase information, to obtain the channel information of the user.

According to the third aspect of the present invention, a first apparatus of feedback in a user equipment in a cell of coordinated multi-point is provided, wherein the user equipment is served by a serving base station and neighboring base stations coordinately, and the first apparatus comprises: a measuring means, for measuring the channel related information between the user equipment and the serving base station, and between the user equipment and the neighboring base stations respectively; a calculating means, for calculating short-term serving channel direction information between the user equipment and the serving base station, long-term neighboring channel direction information between the user equipment and the neighboring base stations, respective relative amplitude information between each one of the neighboring base stations and the serving base station and respective relative phase information between each one of the neighboring base stations and the serving base station according to the channel related information between the user equipment and the serving base station and between the user equipment and the neighboring base stations; the calculating means is further for calculating multi-cell channel quality information according to the short-term serving channel direction information, the long-term neighboring channel direction information, the relative amplitude information and the relative phase information; a feeding back means, for feeding back respectively to the serving base station, the short-term serving channel direction information according to a first period and the long-term neighboring channel direction information according to a second period, and feeding back to the serving base station the relative amplitude information, the relative phase information and the multi-cell channel quality information, wherein the first period is shorter than the second period.

According to the fourth aspect of the present invention, a second apparatus of obtaining the feedback of a user equipment in a serving base station is provided, wherein the serving base station and neighboring base stations serve the user equipment coordinately, and the second apparatus comprises: an obtaining means, for obtaining short-term serving channel direction information between the user equipment and the serving base station according to a first period, obtaining long-term neighboring channel direction information between the user equipment and the neighboring base stations according to a second period, and obtaining respective relative amplitude information between each one of the neighboring base stations and the serving base station and respective relative phase information between each one of the neighboring base stations and the serving base station; a restoring means, for restoring coordinated multi-point quantized channel vector according to the short-term serving channel direction information, the long-term neighboring channel direction information, the relative amplitude information and the relative phase information, to obtain the channel information of the user.

### BRIEF DESCRIPTION OF DRAWINGS

With reference to the following detailed description of the non-restrictive embodiments, other features, objects and advantages of the present invention will be more apparent.

FIG. 1 shows a schematic diagram of the topology structure according to a detailed embodiment of the present invention;

FIG. 2 shows a flowchart of the system method according to a detailed embodiment of the present invention;

FIG. 3 shows an apparatus block diagram according to a detailed embodiment of the present invention;

Wherein same or similar reference numerals refer to same or similar step features or apparatuses (modules).

### DETAILED DESCRIPTION OF EMBODIMENTS

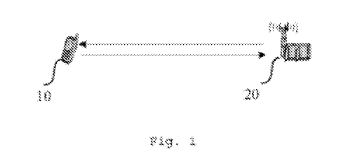

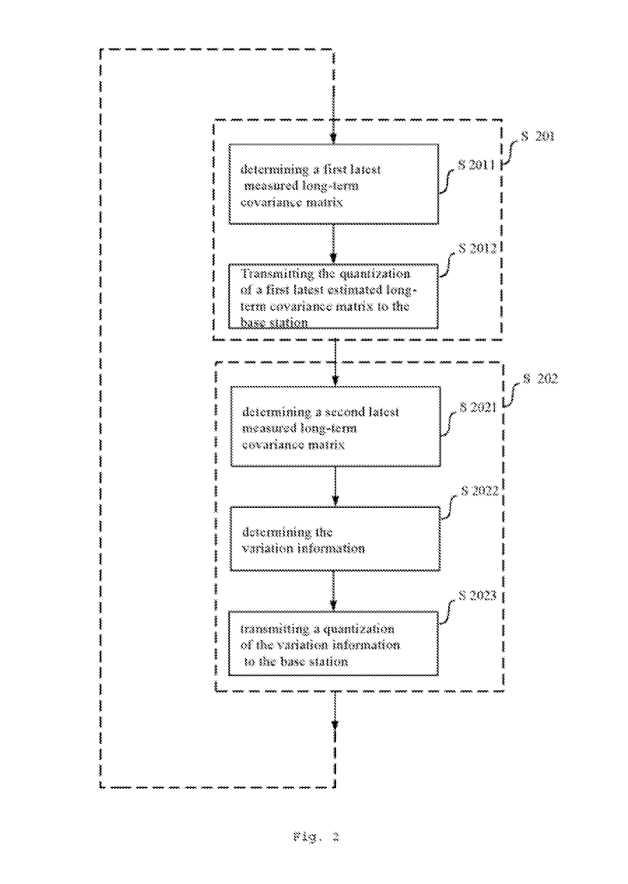

FIG. 1 shows a schematic diagram of the topology structure according to a detailed embodiment of the present invention. In the present invention, a cell of coordinated multi-point is set as an example to be illustrated. Wherein BS 1 is the serving BS of UE 1, BS 2 and BS 3 serve UE 1 coordinately with BS 1. In general, BSs 2 and 3 are neighboring to BS 1, therefore, they are also called neighboring BSs. In the followings, BS 2 and BS 3 are called the neighboring BSs of UE 1. BS 1, BS 2 and BS 3 are all called the coordinated BSs of UE 1. BS 2 is the serving BS of UE 2, and BS 1 and BS 3 are the neighboring BSs of UE 2. BS 3 is the serving BS of UE 3, and BS 1 and BS 2 are the neighboring BSs of UE 3. In the embodiment, only three BSs and three UEs have been shown for the convenience of illustration. Those skilled in the art can understand that, the present invention is also suitable for other topology structures where a plurality of BSs serve a plurality of cells. Moreover, each BS 1, BS 2, BS 3 in the specification has four transmit antennas respectively. Certainly, in the real system, the number of the antennas in the BS is not limited to this.

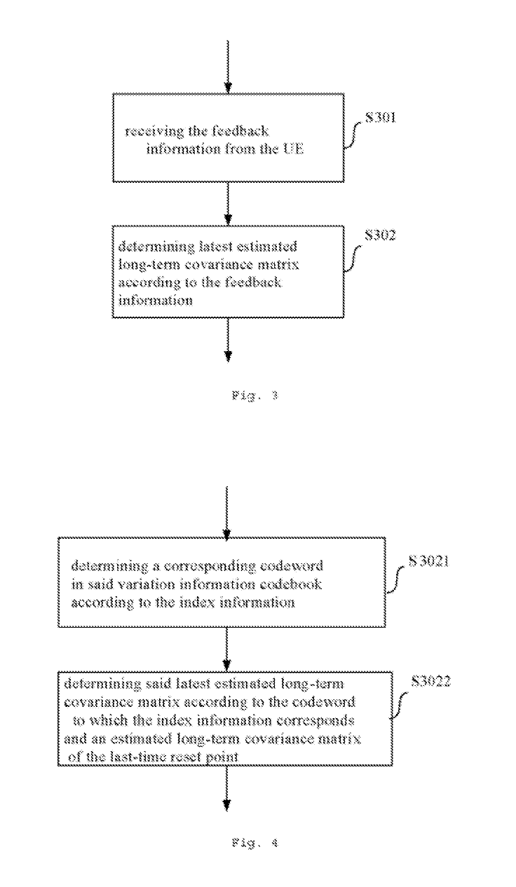

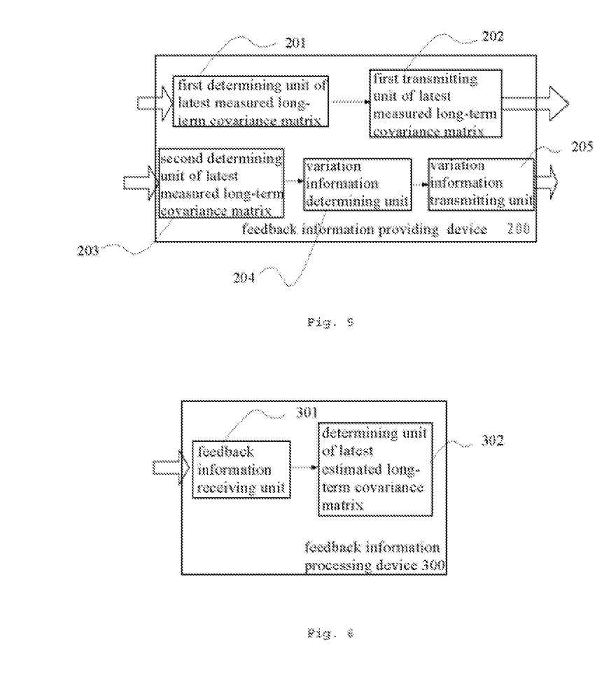

FIG. 2 shows a flowchart of the system method according to a detailed embodiment of the present invention. Firstly, in the step S10, each UE 1, 2 and 3 measures channel related information respectively according to downlink reference signals from BSs 1, 2 and 3, for example, downlink channel matrix H. Firstly UE 1 is set as an example to be illustrated.

For example, UE 1 obtains the channel matrix Hᵢ₁(t, f) (wherein i=1, 2, 3) in subframe t and subcarrier f between BS i (wherein i=1, 2, 3) and UE 1. In the following, in each expression, when a symbol has two subscripts, the first subscript represents the index of the BS and the second subscript represents the index of the UE.

Then, in the step S11, UE 1 calculates short-term serving channel direction information (CDI) between UE 1 and serving BS 1, long-term neighboring CDI between UE 1 and neighboring BS 2, 3, respective relative amplitude information between each one of neighboring BS 2, 3 and serving BS 1 and the respective relative phase information between each one of neighboring BS 2, 3 and serving BS 1 according to the channel matrix H between UE 1 and serving BS 1 and between UE 1 and neighboring BSs 2, 3.

More particularly, firstly, according to the formula below, UE 1 obtains short-term narrowband covariance matrix in subframe t and subband b between BS i (wherein i=1, 2, 3) and UE 1, also, short-term subband covariance matrix:

$${R}_{i 1} ( t , b ) = \frac{1}{\vert {S}_{b} \vert} {\sum }_{f ∈ {S}_{b}} {{H}_{i 1} ( t , f )}^{H} {H}_{i 1} ( t , f )$$

Where, S_{b} is the set of subcarriers in subband b, the cardinality of the subcarriers in subband b is |S_{b}|, the cardinality of the subcarriers in subband b is 60.

Then, according to the formula below, UE 1 obtains the long-term wideband covariance matrix in subframe t between BS i (wherein i=1, 2, 3) and UE 1:

$${\overline{R}}_{i 1} ( t ) = ( 1 - α ) {\overline{R}}_{i 1} ( t - 1 ) + α \frac{1}{\vert S \vert} {\sum }_{f ∈ S} {{H}_{i 1} ( t , f )}^{H} {H}_{i 1} ( t , f )$$

Where S is the set of subcarriers in the whole bands, and its cardinality is |S| for example, the cardinality of the subcarriers in the whole bands is 600, and α is an averaging factor.

Joint multi-cell channel matrix corresponding to UE 1 in subframe t and subcarrier f is H₁(t, f)=[H₁₁(t, f) H₂₁(t, f) H₃₁(t, f)]. It represents cascading three m×n matrices end to end so as to generate a m×(3n) matrix.

Therefore, the long-term covariance matrix and the short-term covariance matrix of UE 1 can be represented as follows:

$${R}_{1} ( t , b ) = \frac{1}{\vert {S}_{b} \vert} {\sum }_{f ∈ {S}_{b}} {{H}_{1} ( t , f )}^{H} {H}_{1} ( t , f )$$

$${\overline{R}}_{1} ( t ) = ( 1 - α ) {\overline{R}}_{1} ( t - 1 ) + α \frac{1}{\vert S \vert} {\sum }_{f ∈ S} {{H}_{1} ( t , f )}^{H} {H}_{1} ( t , f )$$

Principal eigenvector of covariance matrix is usually used to describe the channel characteristic of rank-one transmission, and can be derived according to eigenvalue decomposition of covariance matrix. For example, short-term principal eigenvector Vᵢ₁ between BS i (wherein i=1, 2, 3) and UE 1 is derived from short-term subband covariance matrix Rᵢ₁(t,b), for example, through the eigenvalue decomposition of Rᵢ₁(t,b). For the convenience of illustration, the subscripts of the subframe and subband are omitted. Short-term multi-cell principal eigenvector V₁ for UE 1 is derived from short-term subband multi-cell covariance matrix R₁(t,b), and the subscripts of the subframe and subband are omitted. The long-term spatial statistic information can also be obtained according to the long-term covariance matrix, such as, long-term per-cell principal eigenvector V̅ᵢ₁ and long-term multi-cell principal eigenvector V̅₁.

Then, UE 1 generates the CDI fed back to serving BS 1, the feedback CDI includes individual per-cell channel information and inter-cell relative amplitude/phase information. The detailed quantization procedure is described as follows:

In the prior art, same feedback precision and feedback quality are applied for the channel information between the UE and the serving BS, and the channel information between the UE and the neighboring BSs coordinating with the serving BS for feedback. However, in the present invention, considering the lower path loss, the better antenna direction and the higher beamforming gains between the serving BS and the UE served by it, therefore, in the whole CoMP coordinating cell set, the serving BS has the dominant influence on the gain of the whole system performance. Therefore, according to the embodiment of the present invention, for the feedback of the channel information between the UE and the serving BS, the UE needs to apply relative higher feedback precision and feedback quality, while for the other coordinated neighboring cells, the UE may reduce the channel feedback requirement correspondingly, so as to reduce feedback overhead.

Moreover, in the prior art, same feedback precision and feedback quality are applied for the feedback of the amplitude information and the phase information. Further, considering that the variation of channel amplitude information is more robust compared to that of the phase information, also, channel amplitude information shows time invariant and frequency invariant, while phase information usually varies greater with the variation of time and frequency. Therefore, in a varied embodiment, the UE can also apply different processing manners to feed back inter-cell frequency information and amplitude information. That is, the long-term feedback mechanism is applied for amplitude information, while the short-term feedback mechanism is applied for phase information so as to reduce feedback overhead further.

Per-Cell Channel Information:

Per-cell channel information includes the short-term subband CDI of the serving cell and the long-term wideband CDI of the other coordinated neighboring cells.

According to the minimum chordal distance, each short-term subband V₁₁ is quantized to the closest codeword in the codebook, that is, the CDI of the serving cell is quantized according to the formula below:

$${\hat{V}}_{11} = {arg max}_{\{ {c}_{j}^{T} \} j = 1 , … , N} \vert {V}_{11}^{H} {c}_{j}^{*} \vert$$

Where, cⱼ is each codeword in the codebook, wherein covariance matrix R̅₁₁, (t) is unit-norm column vector, its size is N=2^{B}, C={c₁, . . . , C_{N}}, is a first predefined codebook and B represents feedback bits.

In a varied embodiment, cⱼ represents the codebook weighted by the long-term covariance matrix R̅₁₁(t) of serving BS 1 of UE 1. As cⱼ is a column vector, cⱼ^{T}, the transpose of cⱼ, is a row vector. Therefore \check{V}₁₁ is a row vector.

Moreover, the CDI of the other coordinated neighboring cells can be obtained through the corresponding long-term principal eigenvector V̅ᵢ₁ (i=2, 3), and further quantized according to the minimum chordal distance in the whole hands:

$${\hat{V}}_{i 1} = {arg max}_{\{ {c}_{j}^{T} \} j = 1 , … , N} \vert {\overline{V}}_{i 1}^{H} {c}_{j}^{*} \vert$$

Where, cⱼ is a codebook of unit-norm column vectors of size N=2^{B}, therefore, cⱼ^{T}, the transpose of cⱼ is a row vector. Therefore \check{V}ᵢ₁ is a row vector, and C={c₁, . . . , c_{N}}.

Without loss of generality, in each equation, V represents short-term principal eigenvector measurement, V̅ represents long-term principal eigenvector, \hat{V} represents long-term statistic average quantized principal eigenvector.

Inter-Cell Relative Amplitude Information

Inter-cell relative amplitude information is determined by long-term multi-cell principal eigenvector V̅₁ between all coordinated cells (including the serving cell) and UE 1. Therefore inter-cell relative amplitude information α₁, α₂, α₃ε(0, 1) is calculated as follows, and can be quantized within the range of (0, 1):

α₂=norm( V̅₁(5:8))

α₃=norm( V̅₁(9:12))

α₁=\sqrt{1−α₂²−α₃²}

Also, α₁, α₂, α₃ satisfied α₁²+α₂²+α₃²=1, and the first row to the fourth row of long-term multi-cell principal eigenvector V̅₁ represent BS 1, the fifth row to the eighth row represent BS 2, the ninth row to the twelfth row represent BS 3. Generally, the amplitude information between UE 1 and serving BS 1 is much greater than the amplitude information between BS 2 or BS 3 and UE 1. Therefore, the amplitude information between the coordinated neighboring BSs 2 and 3 and UE 1 is calculated firstly, then the amplitude information between corresponding BS 1 and UE 1 is calculated according to the relationship satisfied by α₁, α₂, α₃.

Inter-Cell Relative Phase Information

Inter-cell relative phase information (φ₁,φ₂) can be determined according to the phase angle between per-cell long-term/short-term CDI feedback \hat{V}ᵢ₁ and short-term multi-cell principal eigenvector measurement V₁, and can be quantized within the range of (0, 2π).

φ₁=mod(angle(V₁(5:8)^{H}\hat{V}₂₁^{H})−angle(V₁(1:4)^{H}\hat{V}₁₁^{H}),2*π)

φ₂=mod(angle(V₁(9:12)^{H}\hat{V}₃₁^{H})−angle(V₁(1:4)^{H}\hat{V}₁₁^{H}),2*π)

Channel Quality Indicator (CQI) Feedback

Then, in the step S12, according to per-cell and inter-cell CDI obtained in the steps described above, UE 1 calculates multi-cell CQI reflecting joint channel quality between all the coordinated cells and UE 1 according to the formula below:

$${CQI}_{MC} = \frac{\frac{3 P}{3 M} {λ}_{1}^{2} {cos}^{2} {θ}_{1}}{{P}_{IN 1} + \frac{3 P}{3 M} {λ}_{1}^{2} {sin}^{2} {θ}_{1}} = \frac{\frac{P}{M} {λ}_{1}^{2} {cos}^{2} {θ}_{1}}{{P}_{IN 1} + \frac{P}{M} {λ}_{1}^{2} {sin}^{2} {θ}_{1}}$$

Where, principal eigenvalue of multi-cell covariance matrix is λ₁². For example, λ₁² can be derived according to eigenvalue decomposition of short-term covariance matrix R.

Phase angle θ₁ between multi-cell principal eigenvector measurement V₁ and multi-cell principal eigenvector quantization \hat{V}₁ can be derived from the equation below:

cos θ₁=|V₁^{H}\hat{V}₁^{H}|.

The measured power of noise and interfering cells (excluding neighboring BS 2 and neighboring BS 3) of UE 1 is P_{IN1}.

Per-cell power constraint is P, per-cell transmit antenna number is M.

Moreover, considering backward compatibility, in order to support single-cell MU-MIMO, UE 1 also needs to report single-cell CQI_{SC} to serving BS 1.

Then, in the step S13, for short-term information and long-term information, UE 1 applies different feedback period for feedback respectively. More particularly, for the CDI between serving BS 1 and UE 1: \hat{V}₁₁ is fed back with a first period, for the respective CDI between other coordinated neighboring BSs 2, 3 and UE 1: (\hat{V}₂₁, \hat{V}₃₁) are fed back with a second period, long-term relative amplitude information (α₂, α₃) is fed back according to a third period, and the short-term relative phase information (φ₁,φ₂) is fed back according to a fourth period. Wherein the first period is shorter than the second period and the third period is longer than the fourth period. Moreover, the value of the first period can also be same with the fourth period, and the value of the second period can also be same with the third period, certainly, they can also be absolutely different. The values of the respective period described above can be configured completely according to the set of the real application system.

In a varied embodiment, when UE 1 utilizes the codebook weighted by long-term covariance matrix \hat{R}₁₁(t) between serving BS 1 and UE 1 to quantize the CDI of the serving cell, UE 1 also needs to feed long-term covariance matrix \hat{R}₁₁(t) back to BS 1, the feedback period of this long-term covariance matrix \hat{R}₁₁(t) can be close to the second period, certainly, can also be a value different from the value of the second period.

Correspondingly, in the step S14, serving BS 1 obtains short-term serving channel direction information \hat{V}₁₁ between UE 1 and serving BS 1 according to a first period, obtains respective long-term neighboring channel direction information (\hat{V}₂₁, \hat{V}₃₁) between UE 1 and neighboring BSs 2, 3 according to a second period, and obtains the respective relative amplitude information (α₂,α₃) between each one of the neighboring BSs and serving BS 1 and the respective relative phase information (φ₁,φ₂) between each one of the neighboring BSs and the serving BS. Moreover, BS 1 also obtains CQI_{MC} fed back by UE 1.

In another embodiment, BS 1 also obtains long-term covariance matrix \hat{R}₁₁(t) between serving BS 1 and UE 1.

In another embodiment, in order to guarantee backward compatibility and support single-cell transmission, UE 1 also obtains CQI_{SC}.

Then, in the step S15, BS 1 restores joint quantized channel vectors between three coordinated cells and UE 1 according to the per-cell channel direction information, inter-cell relative amplitude information and inter-cell relative phase information fed back by UE 1 as well as the inter-cell space characteristics:

$${\hat{V}}_{1} = [ {α}_{1} {\hat{V}}_{11} , {α}_{2} {\hat{V}}_{21} {e}^{j {φ}_{1}} , {α}_{3} {\hat{V}}_{31} {e}^{j {φ}_{2}} ] ,$$

therefore obtaining the channel information of the user.

The present invention is described above from the point of view of the system method flow. In the following, the present invention will be described from the point of view of the apparatus. Wherein first apparatus 10 is set as an example to be illustrated. The first apparatus 10 includes measuring means 100, calculating means 101 and feeding back means 102. Second apparatus 20 includes obtaining means 200 and restoring means 201.

Firstly, measuring means 100 is configured to measure channel matrix H between UE 1 and serving BS 1, and between UE 1 and neighboring BSs 2, 3 respectively.

Then, calculating means 101 is configured to calculate short-term serving channel direction information between UE 1 and serving BS 1, long-term neighboring channel direction information between UE 1 and neighboring BSs 2, 3, respective relative amplitude information between each one of neighboring BSs 2, 3 and serving BS 1 and the respective relative phase information between each one of neighboring BSs 2, 3 and serving BS 1 according to channel matrix H between UE 1 and serving BS, and between UE 1 and neighboring BSs 2, 3.

Calculating means 101 is further configured to calculate multi-cell CQI according to the short-term serving channel direction information, the long-term neighboring channel direction information, the relative amplitude information and the relative phase information.

Then, feeding back means 102 feeds back respectively to serving BS 1, the short-term serving channel direction information according to a first period and the long-term neighboring channel direction information according to a second period, and feeding back to serving BS 1 the relative amplitude information, the relative phase information and the multi-cell channel quality information, wherein the first period is shorter than the second period.

In a varied embodiment, different calculating period and/or feedback period can be applied to the relative amplitude information and the relative phase information. For example, calculating means 101 is further configured to calculate long-term relative amplitude information between each one of neighboring BSs 2, 3 and serving BS 1 and short-term relative phase information between each one of neighboring BSs 2, 3 and serving BS 1 according to the channel related information between UE 1 and serving BS, and between UE 1 and neighboring BSs 2, 3; then, calculate the multi-cell channel quality information according to the short-term serving channel direction information, the long-term neighboring channel direction information, the long-term relative amplitude information and the short-term relative phase information.

Feeding back means 102 feeds back to serving BS 1, the long-term relative amplitude information according to a third period and the short-term relative phase information according to a fourth period respectively, wherein the third period is longer than the fourth period.

Then, obtaining means 200 in second apparatus 20 obtains short-term serving channel direction information between UE 1 and serving BS 1 according to a first period, obtains long-term neighboring channel direction information between UE 1 and neighboring BSs 2, 3 according to a second period, and obtains relative amplitude information between each one of neighboring BSs 2, 3 and serving BS 1 and relative phase information between each one of neighboring BSs 2, 3 and serving BS 1.

Restoring means 201 is configured to restore coordinated multi-point quantized channel vector according to the short-term serving channel direction information, the long-term neighboring channel direction information, the relative amplitude information and the relative phase information, to obtain the channel information of the user.

System Performance Evaluations through System Level Simulations

System performance evaluations are conducted based on the example of FDD. Downlink ZF precoding is based on channel direction information fed back by the UE. Three cells of a same BS construct an intra-site clustering in which centralized multi-cell joint scheduling and coherent transmission are performed. 4×2 Tx/Rx antenna deployment is applied. The basic scheme is single cell MU-MIMO applying one-stream transmission and quantizing by Rel-8 codebook. Multi-cell multi-user joint transmission (MU JT) scheme may schedule maximum 12 UEs in a coordinated cluster, wherein each UE has only one stream. Detailed simulation parameters are listed in Table 1.

TABLE 1

| Simulation Parameter | Assumption |
|---|---|
| Duplex method | FDD |
| Scenario | ITU UMi |
| DL transmission scheme | MU-MIMO: ZF based precoding, max. 4 UEs, |
| | rank 1 per UE |
| | MU JT: three cells of a same BS constructing |
| | an intra-site clustering, ZF based precoding, |
| | max. 12 UEs, rank 1 per UE |
| PMI/CQI measurement | 5-subframe feedback period for PMI/CQI |
| and feedback | 20-subframe feedback period for covariance |
| | matrix R |
| | 6-subframe feedback delay |
| Channel estimation error | Ideal |
| UE speed | 3 km/h |
| Scheduler | Greedy search algorithm based on PF |
| Link to system mapping | RBIR (received block mean mutual information |
| | rate) |
| Control overhead | Fixed 0.3063 |

TABLE 2

| | Cell average SE | Cell-edge SE |
|---|---|---|
| | (spectrum efficiency) | (spectrum efficiency) |
| Transmit scheme | (bps/Hz/cell) | (bps/Hz) |
| MU-MIMO | 3.29 (1.00) | 0.105 (1.00) |
| Traditional CoMP | 4.01 (1.22) | 0.118 (1.12) |
| CoMP proposed by | 3.80 (1.15) | 0.118 (1.12) |
| the present invention | | |

The CoMP scheme proposed by the embodiment of the present invention is compared with the traditional CoMP through system level simulations. Although the CoMP scheme proposed by the embodiment of the present invention has reduced MU-MIMO system performance gains from 22% to 15%, at the same time it has greatly saved uplink feedback overhead, shown as follows:

1) UL feedback overhead for traditional CoMP scheme

a) Per-cell CDI: 4 bit≦3/subband/5-subframe

b) Per-cell covariance matrix: 28 bit×3/20-subframe

c) Inter-cell relative phase: 5 bit×2/subband/5-subframe

d) Inter-cell relative amplitude: 5 bit×2/subband/5-subframe

e) Multi-cell CQI and single-cell CQI: 5 bit×2/subband/5-subframe

f) Total overhead: (42×10+28×3/4)/5=88.2 bits per subframe for each UE

2) UL feedback overhead for CoMP scheme proposed by the embodiment of the present invention

a) Serving cell CDI: 4 bit/subband/5-subframe

b) Serving cell covariance matrix: 28 bit×1/20-subframe

c) Coordinated neighboring cell CDI: 4 bit×2/20-subframe

d) Inter-cell relative phase: 5 bit×2/subband/5-subframe

e) Inter-cell relative amplitude: 5 bit×2/20-subframe

f) Multi-cell CQI and single-cell CQI: 5 bit×2/subband/5-subframe

g) Total overhead: (24×10+18/4+28/4)/5=50.3 bits per subframe for each UE

It follows that the CoMP scheme proposed in the embodiment of the present invention has greatly reduced uplink feedback overhead from 88.2 bits per subframe to 50.3 bits per subframe, and still has about 15% system performance gains compared with single-cell MU-MIMO.

It should be noted that, the embodiments described above are for purpose of illustration only, and not construed as limitation of the invention. Any technology solution without departing from the spirit of the present invention is in the scope of the present invention. This includes combining different technology features appearing in the different embodiments to acquire beneficial effects. Moreover, any reference numeral in the claims should not be considered as the limitation to the related claim; terms “include”, “comprise” do not exclude other apparatuses or steps that have not been listed in the claims or the specification; an indefinite article “a” or “an” preceding an element does not exclude the existence of a plurality of these kinds of elements; in an apparatus comprising a plurality of means, one or more functions in these means can be realized by a single hardware or software module; terms “first”, “second”, “third” etc. are only used to represent name other than any specific order.

1. A method of feedback in a user equipment in a cell of coordinated multi-point, wherein the user equipment is served by a serving base station and neighboring base stations coordinately, and the method comprises:
measuring the channel related information between the user equipment and the serving base station, and between the user equipment and the neighboring base stations respectively;
calculating short-term serving channel direction information between the user equipment and the serving base station, long-term neighboring channel direction information between the user equipment and the neighboring base stations, respective relative amplitude information between each one of the neighboring base stations and the serving base station and respective relative phase information between each one of the neighboring base stations and the serving base station according to the channel related information between the user equipment and the serving base station and between the user equipment and the neighboring base stations;
calculating multi-cell channel quality information according to the short-term serving channel direction information, the long-term neighboring channel direction information, the relative amplitude information and the relative phase information;
feeding back respectively to the serving base station, the short-term serving channel direction information according to a first period and the long-term neighboring channel direction information according to a second period, and feeding back to the serving base station the relative amplitude information, the relative phase information and the multi-cell channel quality information, wherein the first period is shorter than the second period.

2. A method according to claim 1, wherein the calculating further comprises:
calculating long-term relative amplitude information between each one of the neighboring base stations and the serving base station and short-term relative phase information between each one of the neighboring base stations and the serving base station according to the channel related information between the user equipment and the serving base station, and between the user equipment and the neighboring base stations;
the calculating further comprises:
calculating the multi-cell channel quality information according to the short-term serving channel direction information, the long-term neighboring channel direction information, the long-term relative amplitude information and the short-term relative phase information;
the feeding back further comprises:
feeding back to the serving base station, the long-term relative amplitude information according to a third period and the short-term relative phase information according to a fourth period respectively, wherein the third period is longer than the fourth period.

3. A method according to claim 2, wherein the calculating the serving channel direction information further comprises:
calculating the short-term narrowband covariance matrix of the channel between the serving base station and the user equipment;
obtaining short-term principal eigenvector of the short-term covariance matrix according to the short-term narrowband covariance matrix;
quantizing the short-term principal eigenvector according to a first predefined codebook to obtain the serving channel information; and/or
the calculating the neighboring channel direction information further comprises:
calculating the long-term wideband covariance matrix of the channel between the neighboring base stations and the user equipment respectively;
obtaining long-term principal eigenvector of the long-term covariance matrix according to the long-term wideband covariance matrix;
quantizing the long-term principal eigenvector according to a second predefined codebook to obtain the neighboring channel information.

4. A method according to claim 3, wherein the first predefined codebook further comprises the codebook transformed by the long-term covariance matrix of the channel between the serving base station and the user equipment.

5. A method according to claim 2, wherein the calculating the long-term relative amplitude information further comprises:
obtaining joint multi-cell channel matrix according to the channel related information between the user equipment and the serving base station, and between the user equipment and the neighboring base stations;
calculating long-term joint multi-cell covariance matrix of the joint multi-cell channel matrix, and the short-term joint multi-cell covariance matrix of the joint multi-cell channel matrix;
obtaining the relative amplitude information between each of the neighboring base stations and the serving base station according to the long-term joint multi-cell covariance matrix, and obtaining the relative phase information between each of the neighboring base stations and the serving base station according to the short-term joint multi-cell covariance matrix.

6. A method according to claim 1, wherein the calculating further comprises:
calculating the channel quality information between the serving base station and the user equipment according to the short-term serving channel direction information.

7. A method of obtaining the feedback of a user equipment in a serving base station, wherein the serving base station and neighboring base stations serve the user equipment coordinately, and the method comprises:
obtaining short-term serving channel direction information between the user equipment and the serving base station according to a first period, obtaining long-term neighboring channel direction information between the user equipment and the neighboring base stations according to a second period, and obtaining respective relative amplitude information between each one of the neighboring base stations and the serving base station and respective relative phase information between each one of the neighboring base stations and the serving base station;
restoring coordinated multi-point quantized channel vector according to the short-term serving channel direction information, the long-term neighboring channel direction information, the relative amplitude information and the relative phase information, to obtain the channel information of the user.

8. A first apparatus of feedback in a user equipment in a cell of coordinated multi-point, wherein the user equipment is served by a serving base station and neighboring base stations coordinately, and the first apparatus comprises:
a measuring means, for measuring the channel related information between the user equipment and the serving base station, and between the user equipment and the neighboring base stations respectively;
a calculating means, for calculating short-term serving channel direction information between the user equipment and the serving base station, long-term neighboring channel direction information between the user equipment and the neighboring base stations, respective relative amplitude information between each one of the neighboring base stations and the serving base station and respective relative phase information between each one of the neighboring base stations and the serving base station according to the channel related information between the user equipment and the serving base station and between the user equipment and the neighboring base stations;
and the calculating means is further for calculating multi-cell channel quality information according to the short-term serving channel direction information, the long-term neighboring channel direction information, the relative amplitude information and the relative phase information;
a feeding back means, for feeding back respectively to the serving base station, the short-term serving channel direction information according to a first period and the long-term neighboring channel direction information according to a second period, and feeding back to the serving base station the relative amplitude information, the relative phase information and the multi-cell channel quality information, wherein the first period is shorter than the second period.

9. A first apparatus according to claim 8, wherein the calculating means is further for:
calculating long-term relative amplitude information between each one of the neighboring base stations and the serving base station and short-term relative phase information between each one of the neighboring base stations and the serving base station according to the channel related information between the user equipment and the serving base station, and between the user equipment and the neighboring base stations;
calculating the multi-cell channel quality information according to the short-term serving channel direction information, the long-term neighboring channel direction information, the long-term relative amplitude information and the short-term relative phase information;
and the feeding back means is further for:
feeding back to the serving base station, the long-term relative amplitude information according to a third period and the short-term relative phase information according to a fourth period respectively, wherein the third period is longer than the fourth period.

10. A first apparatus according to claim 9, wherein the calculating means is further for:
calculating the short-term narrowband covariance matrix of the channel between the serving base station and the user equipment;
obtaining short-term principal eigenvector of the short-term covariance matrix according to the short-term narrowband covariance matrix;
quantizing the short-term principal eigenvector according to a first predefined codebook to obtain the serving channel information;
calculating the long-term wideband covariance matrix of the channel between the neighboring base stations and the user equipment respectively;
obtaining long-term principal eigenvector of the long-term covariance matrix according to the long-term wideband covariance matrix;
quantizing the long-term principal eigenvector according to a second predefined codebook to obtain the neighboring channel information.

11. A first apparatus according to claim 10, wherein the first predefined codebook further comprises the codebook transformed by the long-term covariance matrix of the channel between the serving base station and the user equipment.

12. A first apparatus according to claim 9, wherein the calculating means is further for:
obtaining joint multi-cell channel matrix according to the channel related information between the user equipment and the serving base station, and between the user equipment and the neighboring base stations;
calculating long-term joint multi-cell covariance matrix of the joint multi-cell channel matrix, and the short-term joint multi-cell covariance matrix of the joint multi-cell channel matrix;
obtaining the relative amplitude information between each of the neighboring base stations and the serving base station according to the long-term joint multi-cell covariance matrix, and obtaining the relative phase information between each of the neighboring base stations and the serving base station according to the short-term joint multi-cell covariance matrix.

13. A first apparatus according to claim 8, wherein the calculating means is further for:
calculating the channel quality information between the serving base station and the user equipment according to the short-term serving channel direction information.

14. A second apparatus of obtaining the feedback of a user equipment in a serving base station, wherein the serving base station and neighboring base stations serve the user equipment coordinately, and the second apparatus comprises:
an obtaining means, for obtaining short-term serving channel direction information between the user equipment and the serving base station according to a first period, obtaining long-term neighboring channel direction information between the user equipment and the neighboring base stations according to a second period, and obtaining respective relative amplitude information between each one of the neighboring base stations and the serving base station and respective relative phase information between each one of the neighboring base stations and the serving base station;
a restoring means, for restoring coordinated multi-point quantized channel vector according to the short-term serving channel direction information, the long-term neighboring channel direction information, the relative amplitude information and the relative phase information, to obtain the channel information of the user.
